(19) United States
(12) Patent Application Publication
(10) Pub. No.: US 2016/0073824 A1
(43) Pub. Date: Mar. 17, 2016

(54) Heated Dual-Wall Carafe Apparatus and Method

(71) Applicant: BREVILLE PTY LIMITED, Alexandria, New South Wales (AU)

(72) Inventors: Richard Harrod, Erskineville, NSW (AU); Gerard Andrew White, Darlington, NSW (AU)

(21) Appl. No.: 14/787,470

(22) PCT Filed: Apr. 30, 2014
(86) PCT No.: PCT/AU2014/000476

§ 371 Date: Oct. 28, 2015

(30) Foreign Application Priority Data
Apr. 30, 2013 (AU) 2013901499

(51) Int. Cl. A47J 41/02; B65D 81/38; A47J 41/00

(52) U.S. Cl. CPC A47J 41/022; A47J 41/0072; B65D 81/3841

(57) ABSTRACT

An insulated carafe device. The device including: a body that comprises an outer sidewall; an internal wall that forms an internal reservoir; the outer sidewall and internal wall defining a cavity there between; and the internal reservoir being adapted to be heated by a heat source.

### FIELD OF THE INVENTION

The invention relates to carafes, and more particularly to thermally insulated carafes.

The invention has been developed primarily for use as a thermally insulated carafe having a fluid reservoir that is heated and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

The present invention concerns itself with carafes, particularly carafes that are used in conjunction with drip filter coffee makers. Drip filter coffee makers generally dispense brewed coffee from an opening that is elevated above a station for a carafe. In coffee makers of this type, the station typically comprises a warming plate situated below a removable carafe. The warming plate is intended to keep the coffee in the carafe warm. However, the continuous operation of the warming plate, besides consuming electricity, tends to degrade the quality of the coffee contained in the carafe.

Known drip filter coffee machines typically use a single wall carafe, which is maintained on a heating element for maintaining suitable temperature in the coffee. However, these devices typically result in the coffee being ‘burnt’, due to prolonged heating.

In more sophisticated examples of the drip coffee maker, the single wall glass carafe and warming plate is replaced by a thermally insulated carafe. By way of example, a thermally insulated carafe is taught by United States Patent Application Publication No 2009/0308878 A1, which is hereby incorporated by reference in its entirety. However, continued use and opening of the reservoir reduced the effectiveness of the thermal insulation.

### OBJECT OF THE INVENTION

It is an object of the present invention to overcome or ameliorate at least one of the disadvantages of the prior art, or to provide a useful alternative.

It is an object of the invention in its preferred form to provide a thermally insulated carafe having inner and outer side walls that define a vacuum chamber and an internal reservoir, and an opening into the reservoir, wherein fluid in the internal reservoir can be heated or temperature controlled/regulated.

### SUMMARY OF THE INVENTION

According to the invention there is provided a thermally insulated carafe having an outer side wall, and an inner sidewall that define a chamber there between, the inner sidewall forming an internal reservoir for retaining fluid therein, and an opening being in fluid communication with the reservoir.

According to an aspect of the invention there is provided an insulated carafe, the carafe including:
a body that comprises an outer sidewall;
an internal wall that forms an internal reservoir;
the outer sidewall and internal wall defining a cavity there between; and
the internal reservoir being adapted to be heated by a heat source.

Preferably, an upper extremity of the outer sidewall has a cap. More preferably, the lower portion of the body comprises a base portion adjoining a lower extremity of the outer sidewall.

Preferably, the cap can include, or form, an opening. More preferably, the internal reservoir is in fluid communication with the cap opening.

Preferably, a base of the internal reservoir is adapted to receive heat from the heat source. The heat source can be remote from, or coupled to, the base of the internal reservoir.

Preferably, the cavity includes vacuum cavity. More preferably, the cavity includes one or more vacuum cavities. Most preferably, the vacuum cavity provide thermal insulation for the internal reservoir.

### BRIEF DESCRIPTION OF THE DRAWINGS

A preferred embodiment of the invention will now be described, by way of example only, with reference to the accompanying drawings in which:

FIG. 1A is a schematic side view of an embodiment carafe;

FIG. 1B is a schematic side view of an embodiment apparatus using the carafe of FIG. 1A;

FIG. 1C is a schematic side view of an embodiment apparatus using the carafe of FIG. 1A;

FIG. 2A is a schematic side view of an embodiment carafe;

FIG. 2B is a schematic side view of an embodiment apparatus using the carafe of FIG. 2A;

FIG. 2C is a schematic side view of an embodiment apparatus using the carafe of FIG. 2A;

FIG. 3A is a schematic side view of an embodiment carafe;

FIG. 3B is a schematic side view of an embodiment apparatus using the carafe of FIG. 3A;

FIG. 3C is a schematic side view of an embodiment apparatus using the carafe of FIG. 3A;

FIG. 4A is a schematic side view of an embodiment carafe;

FIG. 4B is a schematic side view of an embodiment apparatus using the carafe of FIG. 4A;

FIG. 4C is a schematic side view of an embodiment apparatus using the carafe of FIG. 4A;

FIG. 5A is a schematic side view of an embodiment carafe;

FIG. 5B is a schematic side view of an embodiment apparatus using the carafe of FIG. 5A; and

FIG. 5C is a schematic side view of an embodiment apparatus using the carafe of FIG. 5A.

### PREFERRED EMBODIMENT OF THE INVENTION

Referring to the figures, embodiment dual wall carafe having a vacuum cavity are shown for use with a drip filter coffee appliance. The dual wall carafe has a vacuum cavity for providing thermal insulation between an internal reservoir and the exterior of the carafe. The internal reservoir is further adapted to receive heat from a heat source.

By way of example, an embodiment insulated carafe includes a body 100 that comprises a substantially cylindrical outer sidewall 101. The upper extremity 102 of the outer sidewall 101 (for example, being substantially round) having a cap 103. The lower portion of the body comprises a base portion 104 adjoining a lower extremity 105 of the outer sidewall 101. The cap can include, or form, an opening (typically at its highest point). An internal sidewall 106 and internal base 107 forms a reservoir 108 in fluid communication with the cap opening.

The internal base 107 or internal reservoir 108 can be adapted to receive heat from a heat source 109. The heat source can be remote from, or coupled to, the internal base or internal reservoir.

It will be appreciated that thermal insulation is provided to effect at least some thermally insulation for at least a portion internal reservoir from the outer wall. For example, thermal insulation can be in the form of a vacuum cavity between the internal reservoir and the outer wall.

It will be further appreciated that the insulated carafe can, by way of example only, be used in a drip filter coffee apparatus 110.

Referring to the figures, embodiments will now be described by way of example only.

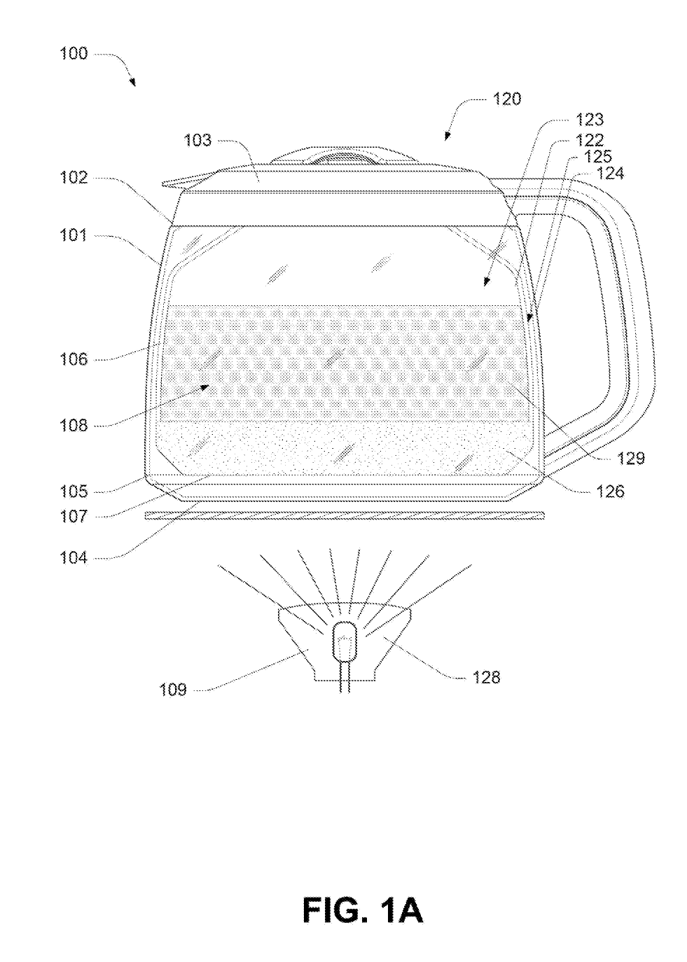

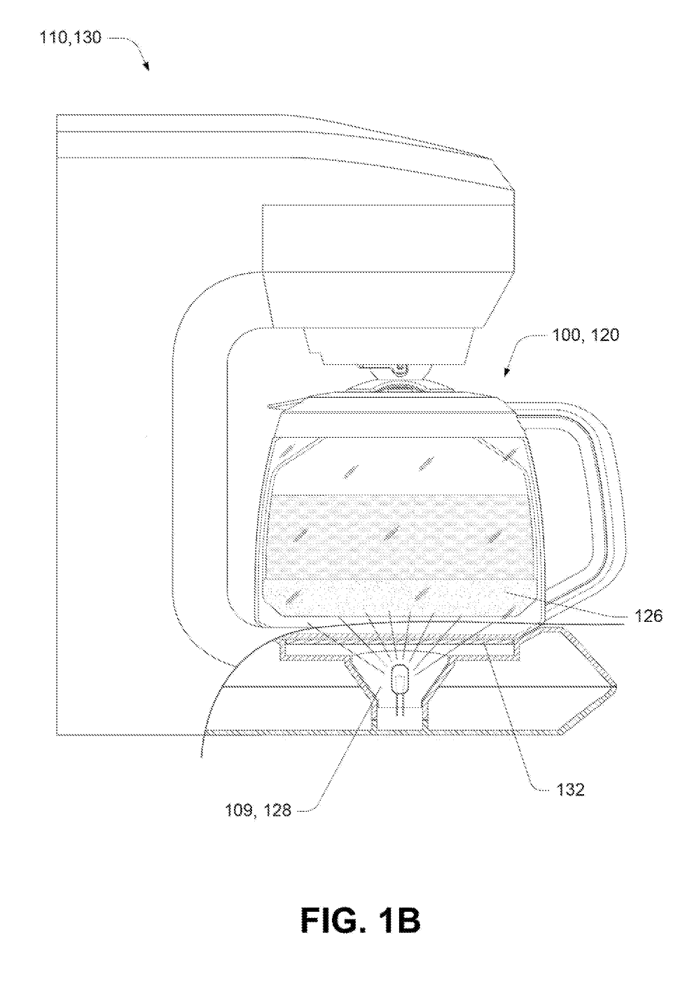

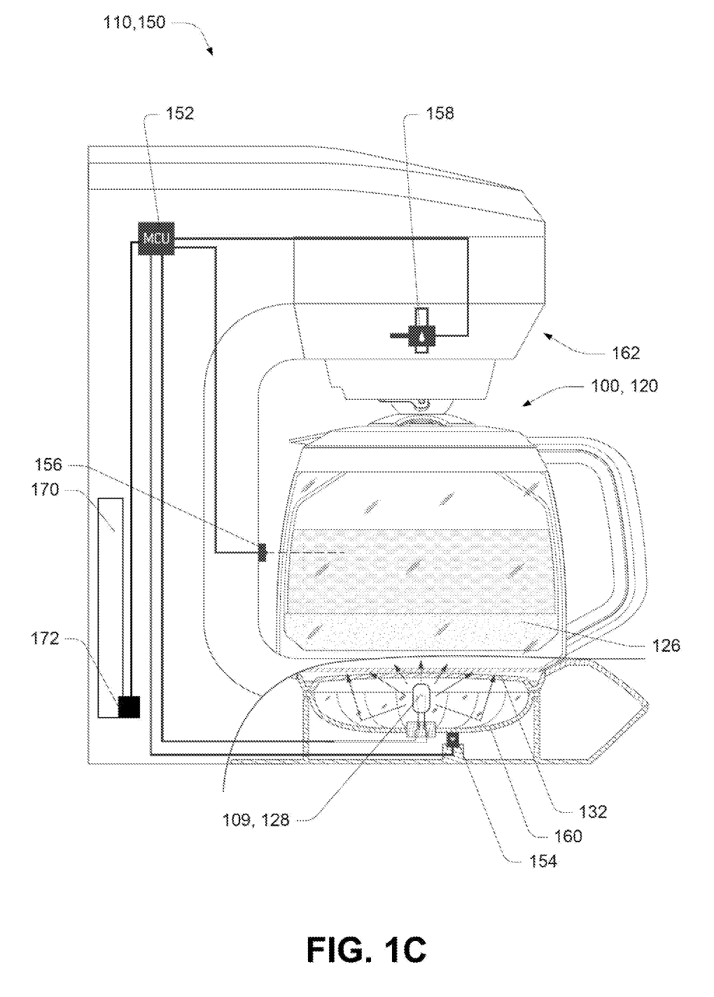

Referring to FIG. 1A, an embodiment insulated carafe is in the form of a dual wall glass carafe 120 defined by internal glass wall 122 defining a reservoir 123 and an outer glass wall 124, having a cavity 125 there between.

In this embodiment, a portion 126 of the internal reservoir glass wall 122 is adapted through being painted or etched for receiving heat from a heat source 128. For example, the heat source can be in the form of an infrared heat source (or bulb) or a halogen heat source (or bulb) that heats the opaque surface on the internal reservoir glass wall. It will be appreciated that the heat source can be used to: pre-warm the internal reservoir, or maintain temperature if (or heat) coffee 129 held by the internal reservoir. It will be further appreciated that, in an alternative embodiment, the internal reservoir glass wall can also be clear.

Referring to FIG. 1B, by way of example only, the glass carafe 120 can be used with a drip filter coffee apparatus 130. In this configuration, a transparent floor 132 can be used to support the carafe 120 while enabling a heat source 128 below to provide heat to the internal reservoir.

It will be appreciated that the external wall is typically transparent (at least the base) when using an infrared heating element or halogen heating element. A portion of the internal reservoir is constructed of a material that can absorb the heat provided by the infrared heating element or halogen heating element, and is directly visible through a substantially transparent portion of the external wall.

FIG. 1C shows the glass carafe 120 (disclosed in FIG. 1A) used with an embodiment drip filter coffee apparatus 150. In this configuration, a translucent (or transparent) floor 132 is used to support the carafe 120 while enabling a heat source 128 below to provide heat to the internal reservoir.

In an embodiment, a control module 152 included to monitor and control operation of the apparatus. The control module 152 is coupled to any one or more of:
a load cell element 154 for providing a load signal indicative of the carafe being presented to the drip filter coffee apparatus;
a temperature sensing element 156 for providing a temperature signal indicative of fluid temperature within the carafe;
a controlled dispenser valve 158 for controlling flow of heated water into the brew region and/or controlling release of brewed coffee from the brew region into the carafe;
a heating source element 128 for selectively heating fluid within the carafe reservoir.

In this embodiment, by way of example only, the heating source 128 is mounted in a concave reflector 160, which is further associated with a load cell element 154. Placement of the carafe on the floor 132 causes movement or pressure applied by the carafe to the load cell element, which causes the load cell element to produce and transmit a signal to the control module 152 for indicating the presence of the carafe. A control module 152 is coupled to the load cell element 154 for receiving the load signal indicative of the carafe being provided to the drip filter coffee apparatus. It will be appreciated that, in some embodiments, the signal transmitted by the load cell element to the control module can be further indicative of the carafe weight (and fluid volume within the carafe). The controller module 152 is also coupled to the heating source 128 for providing selective controlled heating of the fluid in the carafe reservoir. A controlled dispenser valve 158 can be coupled to the control module 152 for enabling controlled release of heated water into a brew region 162 and/or controlled release of the brewed coffee from a brew region 162 into the carafe. It would be appreciated that controlled release of brewed coffee from the brew region 162 (typically including a brew basket or filter) can enable an extended brew time for the coffee grounds in the brew chamber—prior to release into the carafe. A temperature sensor, for example in the form of an infrared sensor 156, can be provided for remote temperature sensing of fluid within the carafe. It will be appreciated that, detecting the presence of the carafe, coffee brewing can be suspended or delayed until a cup or carafe is present.

In an embodiment, by way of example only, the drip filter coffee apparatus 150 can further include a water tank 170. A water level detection element 172 can be operatively associated with the water tank. The water level detection element 172 can be coupled to the controller module 152 for providing a signal and/or data indicative of water level in the water tank. By way of example only, the water level detection element can include any one of the following water level detection means: electronic scales, load sensor, volume sensor, capacitive sensor. By way of example only, the water level detection element can include any water level detection assembly disclosed in U.S. Pat. No. 8,327,753 B2, which is incorporated herein by reference. It will be appreciated that a water tank and/or a water level detection element can be included in any one of the drip filter coffee apparatus disclosed herein.

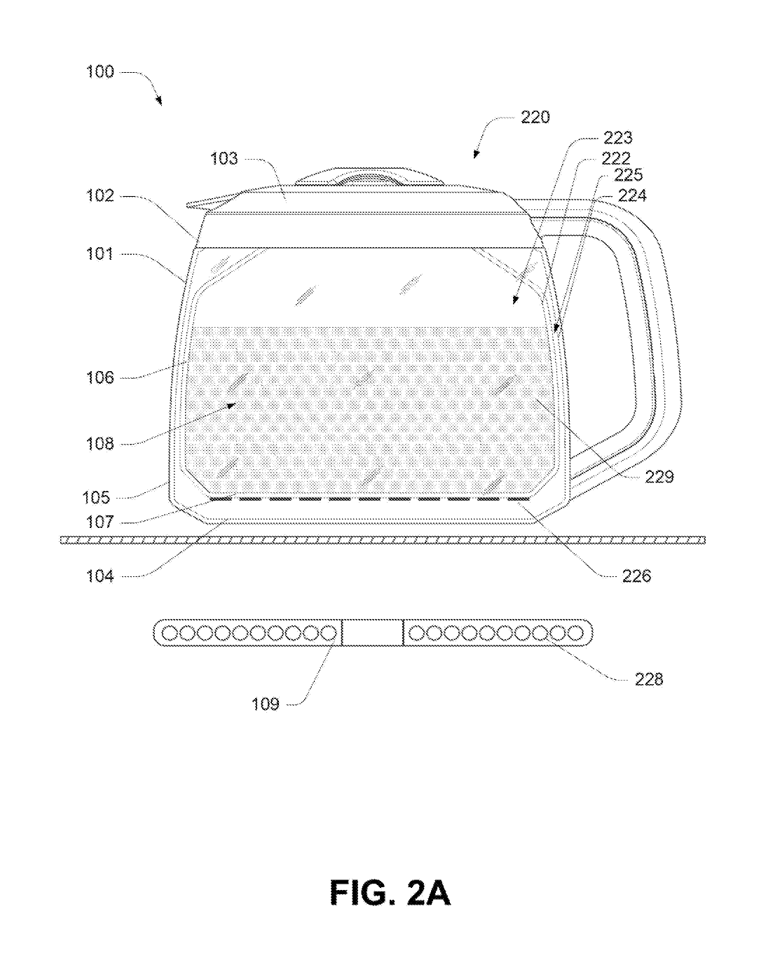

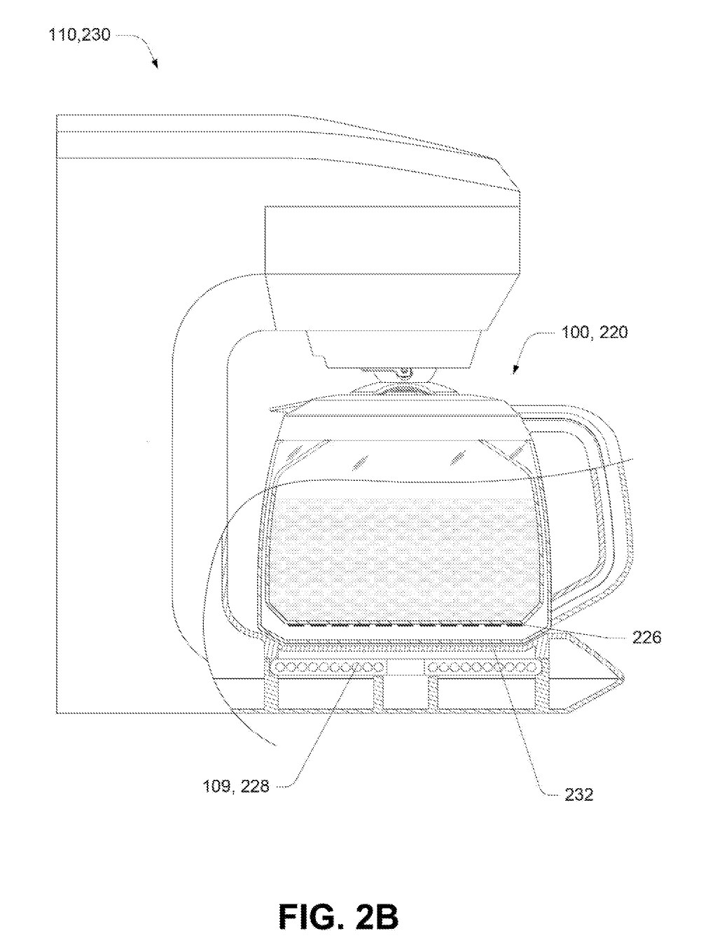

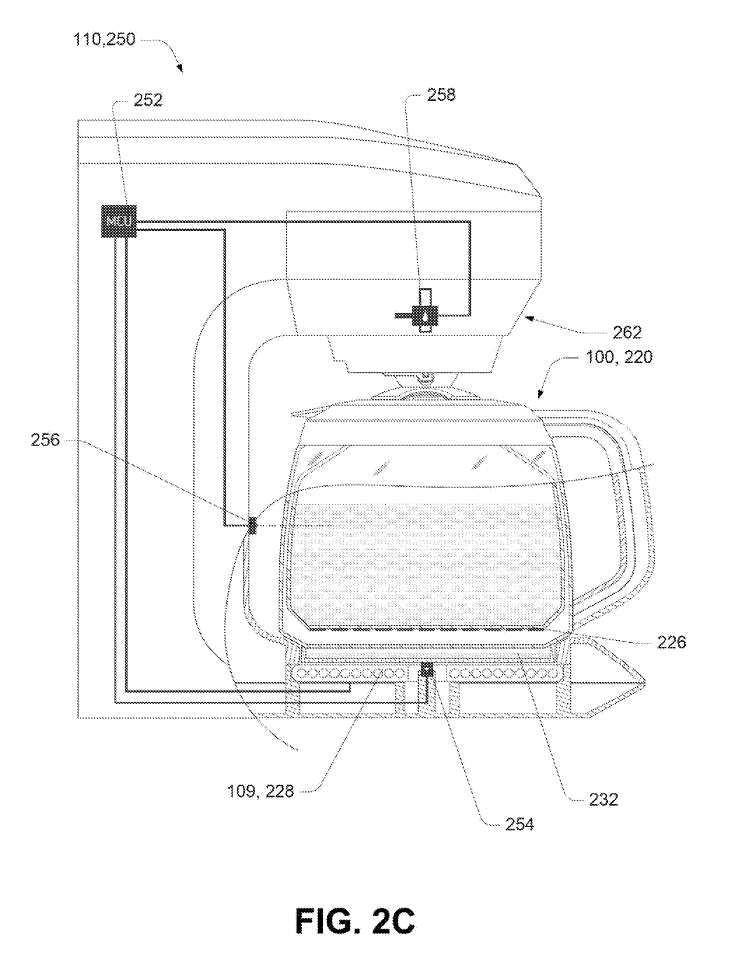

Referring to FIG. 2A, an embodiment vacuum insulated carafe 220 can be in the form of either: a dual walled glass carafe, as dual walled non-ferrous metal carafe (for example aluminium or stainless steel SS304) or a dual wall ceramic carafe. In each embodiment, vacuum insulated carafe 220 has an internal wall 222 defining a reservoir 223 and an outer wall 224, having a vacuum cavity 225 there between.

In this embodiment, the heat source is in the form of an inductive coil heating source 228. It will be appreciated that outer wall is typically constructed from a material that is substantially non reactive to the field produced by the inductive coil, such as glass, non-ferrous metals or ceramic. It will be further appreciated that the internal wall is also primarily constructed of materials that are non-reactive to the field produced by the inductive coil. A portion 226 of the internal reservoir wall can be constructed of an inductive material, or have an inductive material applied thereto. For example the internal reservoir wall can be painted (or have applied on it for example by way of screen printing) an inductive metal which can react to the inductive field produced by the inductive coil heat source to thereby heat, or maintain temperature of, coffee 229 held within the reservoir.

Referring to FIG. 2B, by way of example only, the carafe 220 can be used with a drip filter coffee apparatus 230. In this configuration, a non-ferrous floor material 232 can be used to support the carafe 220 while enabling an inductive heating source 228 below to provide heat to the internal reservoir.

It will be appreciated that the carafe will comprise mostly non-ferrous materials when the associated heating element is an inductive heating element. An inductive material is then associated with the internal reservoir, which absorbs energy from an inductive heating source for heating the reservoir.

FIG. 2C shows the carafe 220 (disclosed in FIG. 2A) used with an embodiment drip filter coffee apparatus 250. In this configuration a non-ferrous floor material floor 232 is used to support the carafe 220 while enabling an inductive heating source 228 below to provide heat to the internal reservoir.

In an embodiment, a control module 252 included to monitor and control operation of the apparatus. The control module 252 is coupled to any one or more of:
a load cell element 254 for providing a load signal indicative of the carafe being presented to the drip filter coffee apparatus;
a temperature sensing element 256 for providing a temperature signal indicative of fluid temperature within the carafe;
a controlled dispenser valve 258 for controlling flow of heated water into the brew region or controlling release of brewed coffee from the brew region into the carafe;
a heating source element 228 for selectively heating fluid within the carafe reservoir.

In this embodiment, by way of example only, the heating source element 228 is located below a non-ferrous material floor 232, which is further associated with a load cell element 254. Placement of the carafe on the floor 232 causes movement or pressure applied by the carafe to the load cell element 254, which causes the load cell element to produce and transmit a signal to the control module 252 for indicating the presence of the carafe. A control module 252 is coupled to the load cell element 254 for receiving the load signal indicative of the carafe being provided to the drip filter coffee apparatus. It will be appreciated that, in some embodiments, the signal transmitted by the load cell element to the control module can be further indicative of the carafe weight (and fluid volume within the carafe). The controller module 252 is also coupled to the heating source 228 for providing selective controlled heating of the fluid in the carafe reservoir. A controlled dispenser valve 258 can be coupled to the control module 252 for enabling controlled release of heated water into a brew region 262 and/or controlled release of the brewed coffee from a brew region 262 into the carafe. It would be appreciated that controlled release of brewed coffee from the brew region 262 (typically including a brew basket or filter) can enable an extended brew time for the coffee grounds in the brew chamber—prior to release into the carafe. A temperature sensor, for example in the form of an infrared sensor 256, can be provided for remote temperature sensing of fluid within the carafe.

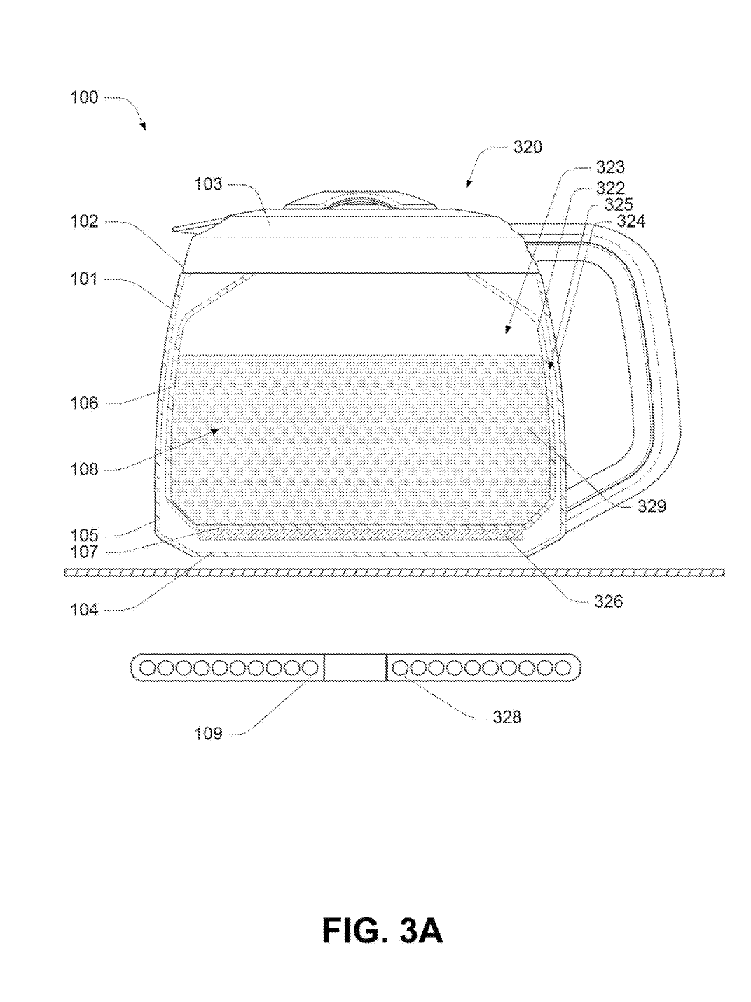

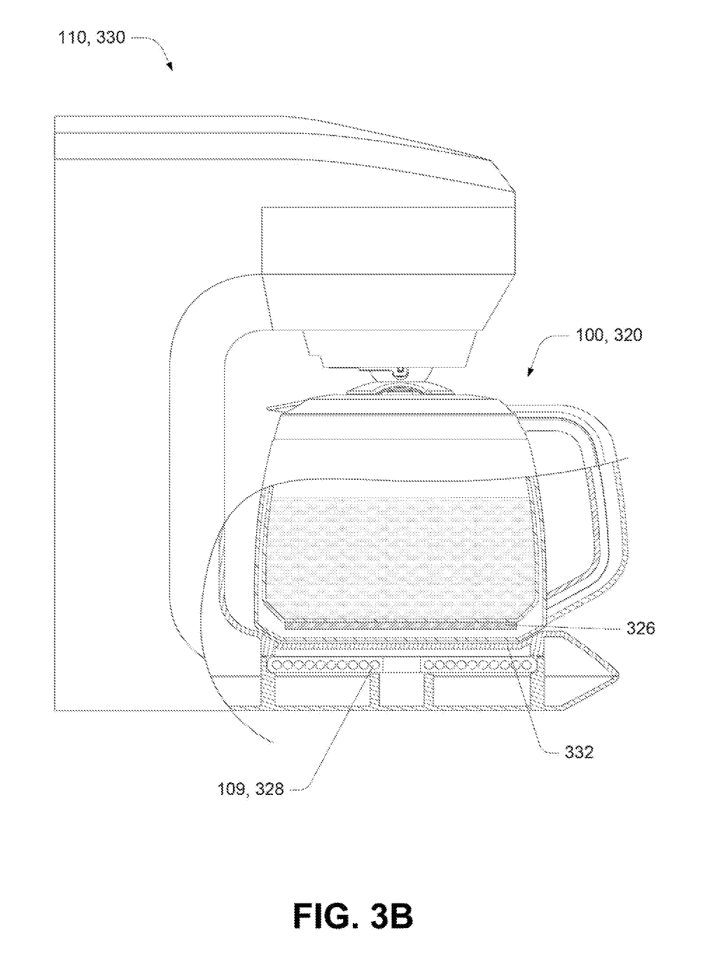

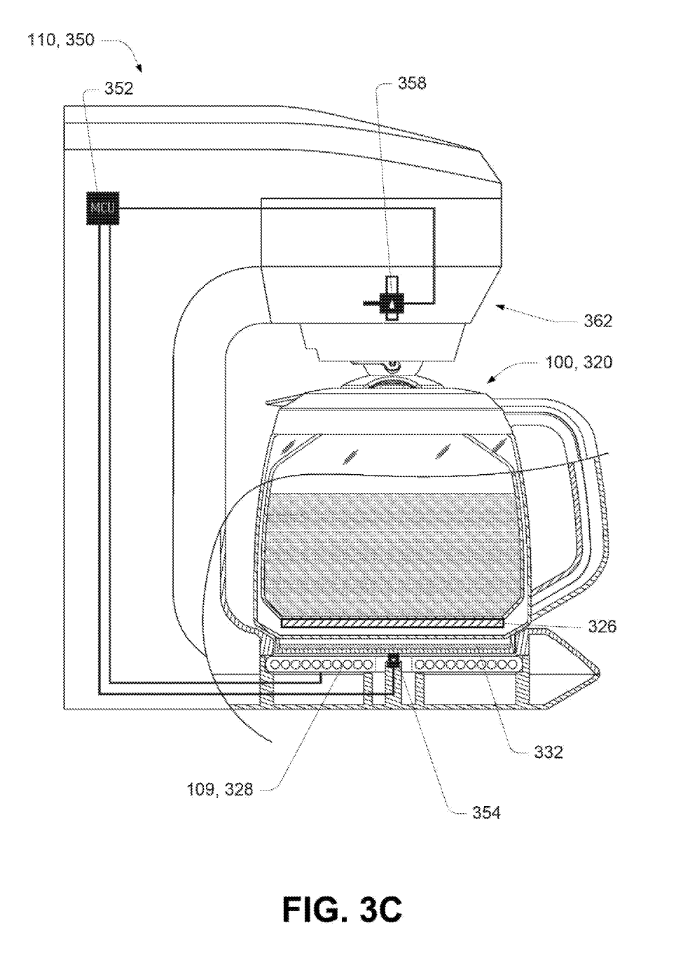

Referring to FIG. 3A, an embodiment vacuum insulated carafe can be in the form of a dual walled metal carafe 320. An internal wall 322 defines an internal reservoir 323. An outer wall 324 defines a vacuum cavity 325 between the internal wall and the outer wall. The internal wall 322 and the external wall 324 are primarily constructed of non-ferrous material. Non-ferrous materials typically used are aluminium or stainless steel SS304.

In this example, a heating source is an inductive coil heat source 328. A ferrous metal heating plate 326 is coupled to the internal reservoir such that, by applying an inductive field produced by the inductive coil 328 to the ferrous heating plate, coffee 329 within the reservoir 323 can be heated (or the temperature maintain/controlled). The ferrous heating plate can, by way of example, be impact bonded or welded to the internal reservoir wall.

Referring to FIG. 3B, by way of example only, the carafe 320 can be used with a drip filter coffee apparatus 330. In this configuration, a non-ferrous floor material 332 can be used to support the carafe 320 while enabling a heat source 328 below to provide heat to the internal reservoir.

FIG. 3C shows the carafe 320 (disclosed in FIG. 3A) used with an embodiment drip filter coffee apparatus 230. In this configuration, a non-ferrous floor material floor 332 is used to support the carafe 320 while enabling an inductive heating source 328 below to provide heat to the internal reservoir.

In an embodiment, a control module 352 included to monitor and control operation of the apparatus. The control module 352 is coupled to any one or more of:
a load cell element 354 for providing a load signal indicative of the carafe being presented to the drip filter coffee apparatus;
a temperature sensing element 356 for providing a temperature signal indicative of fluid temperature within the carafe;
a controlled dispenser valve 358 for controlling flow of heated water into the brew region or controlling release of brewed coffee from the brew region into the carafe;
a heating source element 328 for selectively heating fluid within the carafe reservoir.

In this embodiment, by way of example only, the heating source element 328 is located below a non-ferrous material floor 332, which is further associated with a load cell element 354. Placement of the carafe on the floor 232 causes movement or pressure applied by the carafe to the load cell element 354, which causes the load cell element to produce and transmit a signal to the control module 352 for indicating the presence of the carafe. A control module 352 is coupled to the load cell element 354 for receiving the load signal indicative of the carafe being provided to the drip filter coffee apparatus. It will be appreciated that in some embodiments, the signal transmitted by the load cell element to the control module can be further indicative of the carafe weight (and fluid volume within the carafe). The controller module 352 is also coupled to the heating source 328 for providing selective controlled heating of the fluid in the carafe reservoir. A controlled dispenser valve 358 can be coupled to the control module 352 for enabling controlled release of heated water into a brew region 362 and/or controlled release of the brewed coffee from a brew region 362 into the carafe. It would be appreciated that controlled release of brewed coffee from the brew region 362 (typically including a brew basket or filter) can enable an extended brew time for the coffee grounds in the brew chamber—prior to release into the carafe. It will be appreciated that the controller module 352 can be coupleable to a temperature sensing element (not shown), for monitoring temperature of fluid within the carafe.

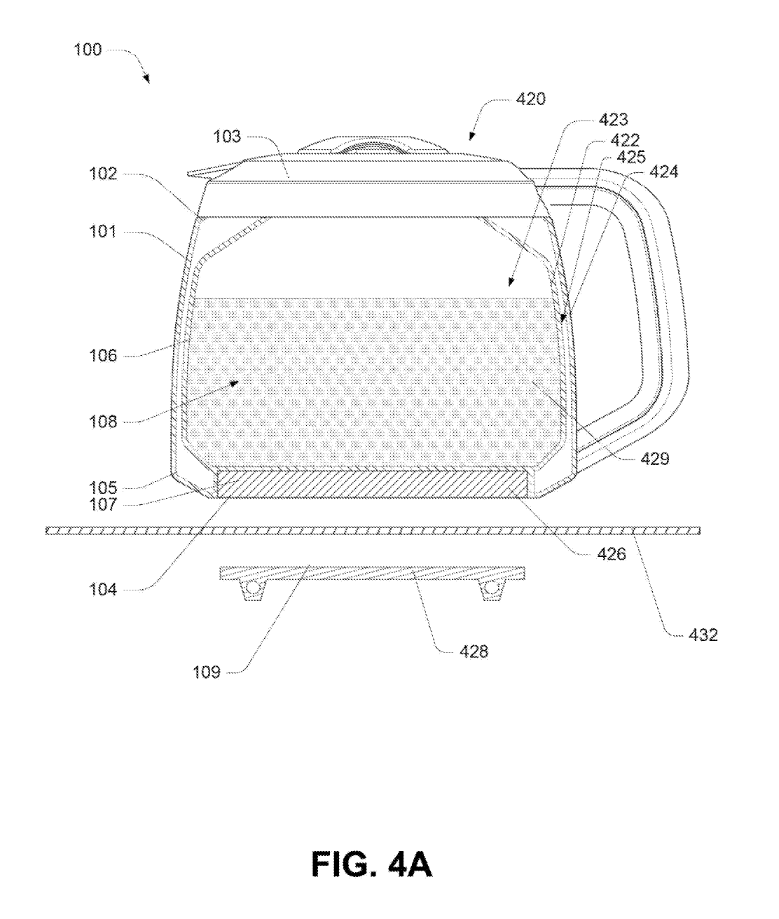

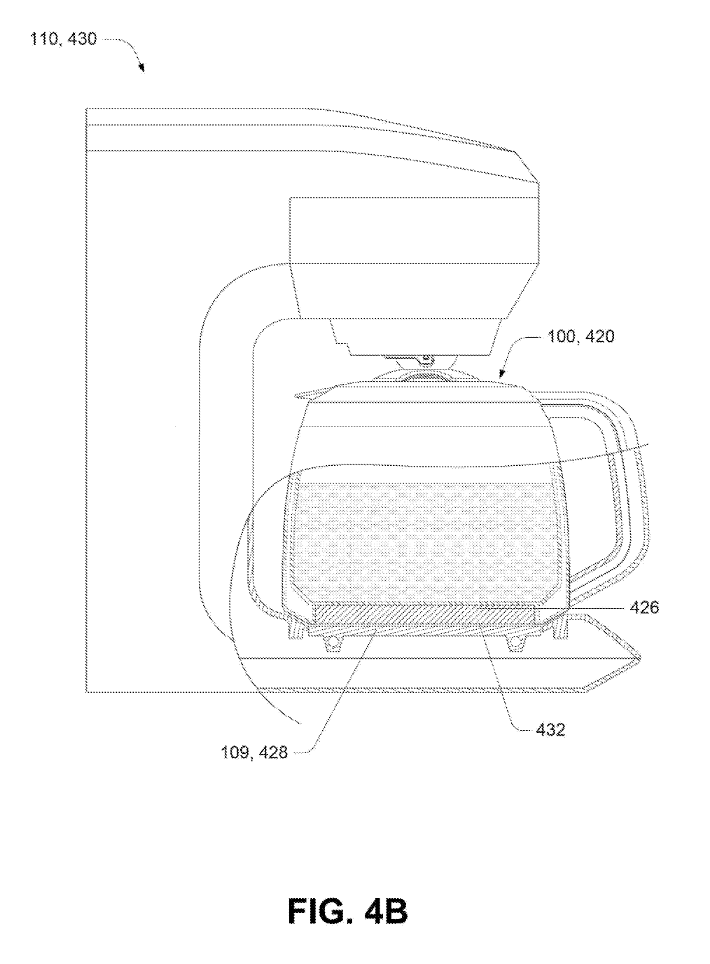

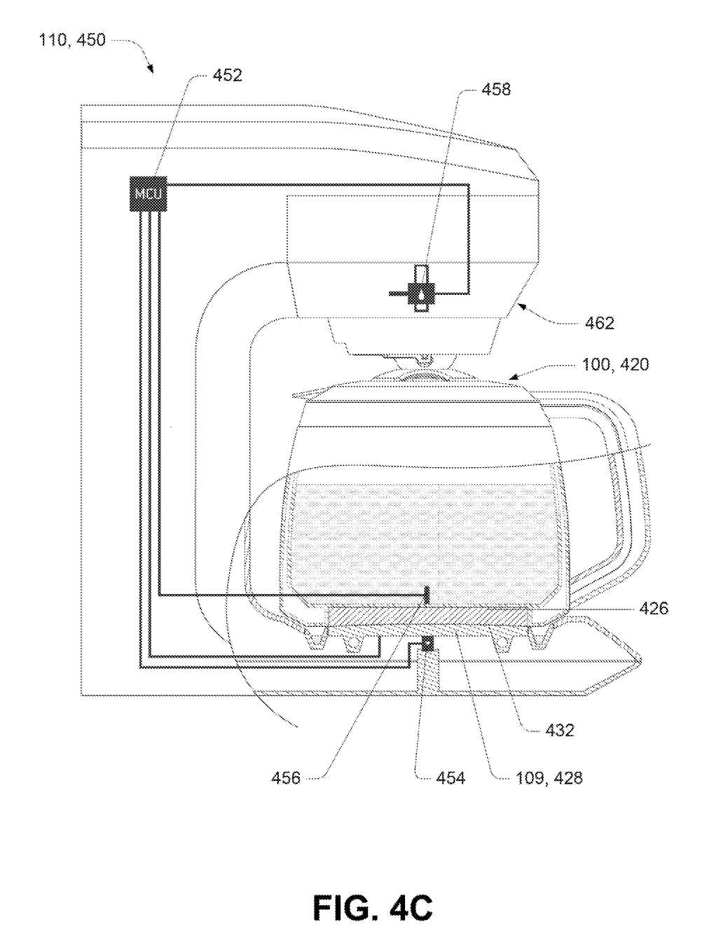

Referring to FIG. 4A, an embodiment vacuum insulated carafe can be in the form of a dual wall carafe 420. An internal wall 422 defines an internal reservoir 423. An outer wall 424 defines a vacuum cavity 425 between the internal wall and the outer wall. A portion 426 of the internal reservoir being thermal coupled to a heat transfer plate for transferring heat external to the carafe to a portion of the internal reservoir.

In this embodiment, a vacuum cavity 425 exists about a substantial portion of the internal reservoir 423. A heat source (for example, a conventional heating element) 428 is used to heat the heat transfer plate, which then heats (or maintains and/or controls) the temperature of the coffee 429 held within the internal reservoir. For example a dual wall metal carafe can have a heat transfer plate located or welded within the carafe for thermally coupling the lower portion of the carafe exterior and internal reservoir for transferring heat between the lower portion of the carafe and the internal reservoir. A vacuum cavity is maintained between the sides of the internal reservoir and the sides of the carafe.

Referring to FIG. 4B, by way of example only, the carafe 420 can be used with a drip filter coffee apparatus 430. In this configuration, the heating clement 428 can be used to support 432 the carafe 420 while enabling a heat source to provide heat to the internal reservoir.

FIG. 4C shows the carafe 420 (disclosed in FIG. 4A) used with an embodiment drip filter coffee apparatus 450. In this configuration, the heating element 428 can be used to support 432 the carafe 420 while enabling a heat source to provide heat to the internal reservoir.

In an embodiment, a control module 452 included to monitor and control operation of the apparatus. The control module 452 is coupled to any one or more of:
a load cell element 454 for providing a load signal indicative of the carafe being presented to the drip filter coffee apparatus;
a temperature sensing element 456 for providing a temperature signal indicative of fluid temperature within the carafe;
a controlled dispenser valve 458 for controlling flow of heated water into the brew region or controlling release of brewed coffee from the brew region into the carafe;
a heating source element 428 for selectively heating fluid within the carafe reservoir.

In this embodiment, by way of example only, the heating source element 428 is located below (or defines) a supporting floor 432, which is further associated with a load cell element 454. Placement of the carafe on the floor 432 causes movement or pressure applied by the carafe to the load cell element 454, which causes the load cell element, to produce and transmit a signal to the control module 452 for indicating the presence of the carafe. A control module 452 is coupled to the load cell element 454 for receiving the load signal indicative of the carafe being provided to the drip filter coffee apparatus. It will be appreciated that, in some embodiments, the signal transmitted by the load cell element to the control module can be further indicative of the carafe weight (and fluid volume within the carafe). The controller module 452 is also coupled to the heating source 428 for providing selective controlled heating of the fluid in the carafe reservoir. A controlled dispenser valve 458 can be coupled to the control module 452 for enabling controlled release of heated water into a brew region 462 and/or controlled release of the brewed coffee from a brew region 462 into the carafe. It would be appreciated that controlled release of brewed coffee from the brew region 462 (typically including a brew basket or filter) can enable an extended brew time for the coffee grounds in the brew chamber—prior to release into the carafe. A temperature sensor, for example in the form of an thermistor 456, can be located within or about (and preferably thermally coupled to) the reservoir for provided for temperature sensing of fluid within the carafe.

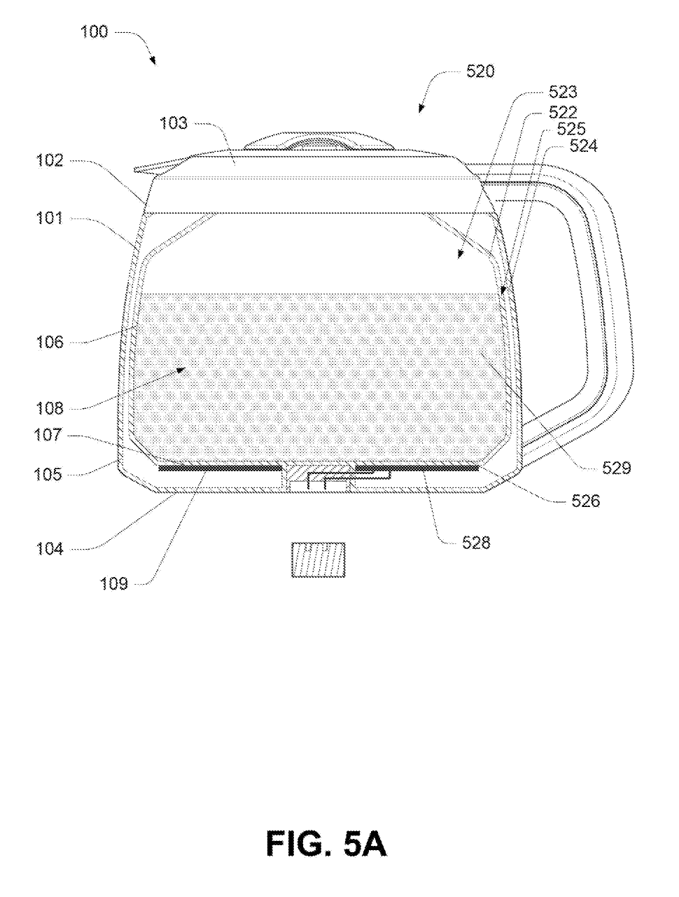

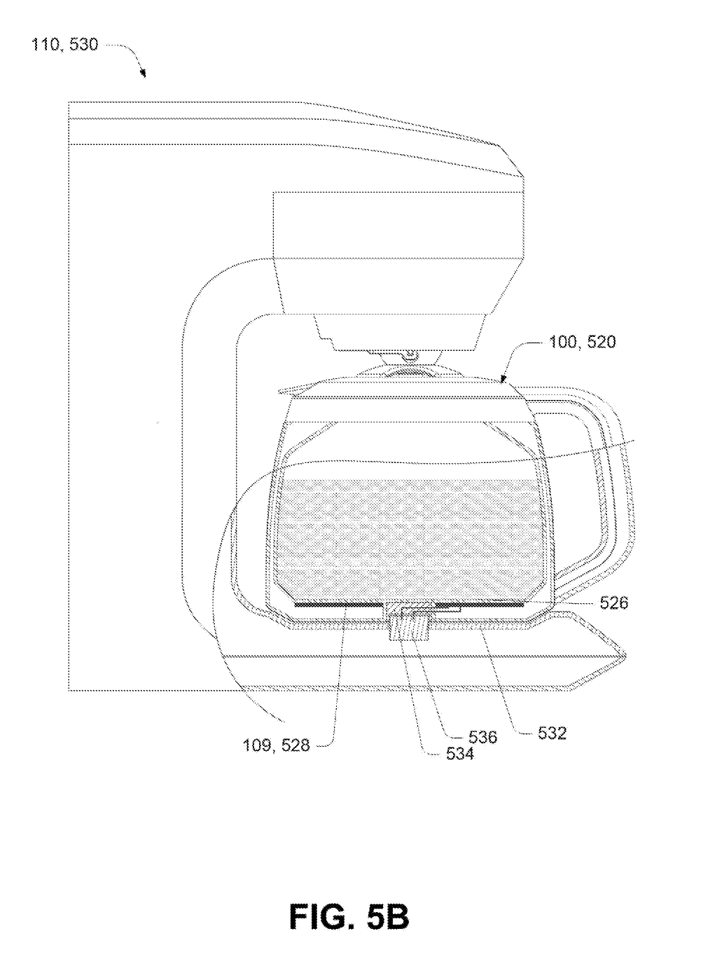

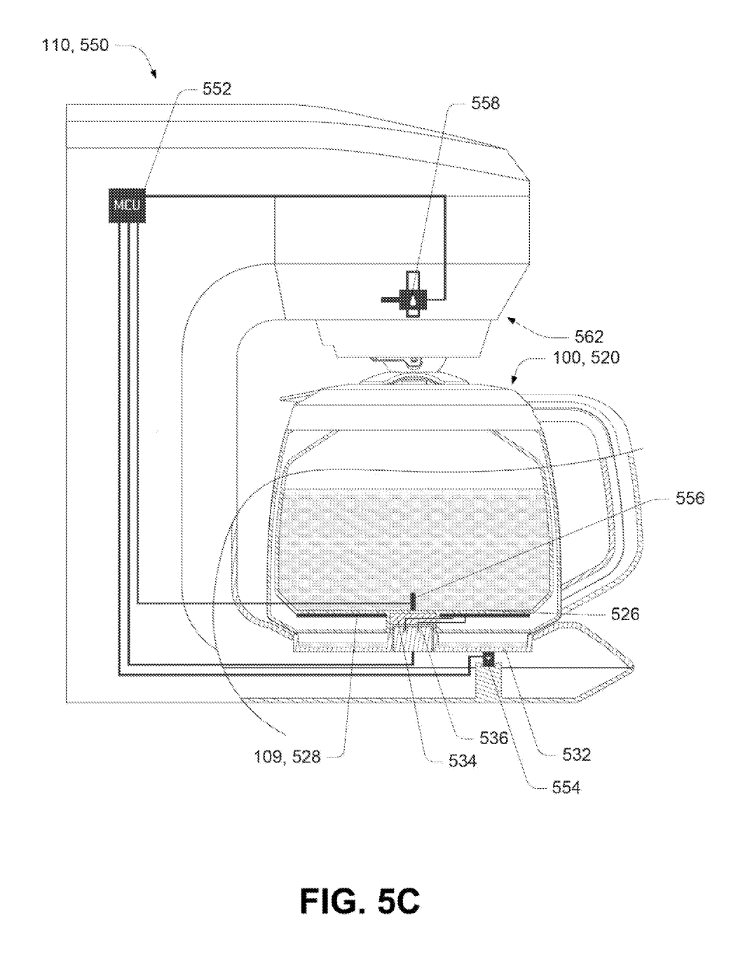

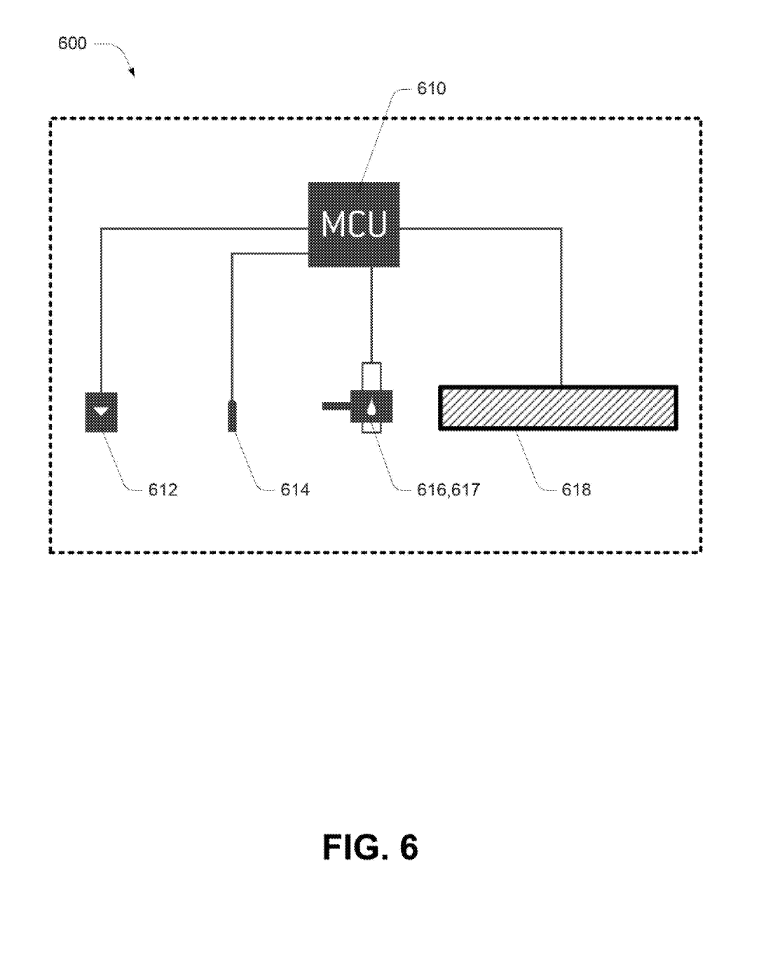

Referring to FIG. 5A, an embodiment vacuum insulated carafe can be in the form of a dual wall carafe 520. An internal wall 522 defines an internal reservoir 523. An outer wall 524 defines a vacuum cavity 525 between the internal wall and the outer wall. A portion 526 of the an internal reservoir is thermally coupled to an electrical heating element 528. A releasable power coupling is used to provide power to the electrical heating element. The electrical heating element can be a printed heating element which is printed to the base of the internal reservoir or the outer floor of the internal reservoir.

Referring to FIG. 5B, by way of example only, the carafe 520 can be used with a drip filter coffee apparatus 530. In this configuration, a surface 532 can be used to support the carafe 520 while coupling of the first power coupling element 534 and the second power coupling element 536 for enabling powering of the heat source 528 to provide heat to the internal reservoir.

By way of example only, a first power coupling element is located at the base of the carafe for engaging with a second power coupling element associated with a supporting apparatus for providing power to the heating element. It will be appreciated that the coupling element can occupy a portion of the floor of the internal reservoir, while enabling a vacuum cavity to be formed between a substantial portion of the internal reservoir and the external wall. Alternatively, the power coupling element can be formed in the external wall, thereby enabling a vacuum cavity to be formed across the entire floor of the internal reservoir.

It would be appreciated that when an electrical heating element is used, the carafe can be typically constructed of any suitable material. The electrical heating element is coupled to the internal reservoir, with lead wires being either drawn across the backing cavity to the external wall or through a transfer portion between the internal reservoir and exterior wall.

It will be appreciated that a vacuum cavity is preferably defined between a substantial portion of the internal reservoir and the external wall, in particular about the sides and floor of the internal reservoir. It will be further appreciated that the vacuum cavity need not be between all of the reservoir side wall and/or all of the reservoir floor (for example, as shown in FIG. 4A and FIG. 5A).

FIG. 5C shows the carafe 520 (disclosed in FIG. 5A) used with an embodiment drip filter coffee apparatus 550. In this configuration, a surface 532 can be used to support the carafe 520 while coupling of the first power coupling element 534 and the second power coupling element 536 for enabling powering of the heat source 528 to provide heat to the internal reservoir.

In an embodiment, a control module 552 included to monitor and control operation of the apparatus. The control module 552 is coupled to any one or more of:
a load cell element 554 for providing a load signal indicative of the carafe being presented to the drip filter coffee apparatus;
a temperature sensing element 555 for providing a temperature signal indicative of fluid temperature within the carafe;
a controlled dispenser valve 558 for controlling flow of heated water into the brew region or controlling release of brewed coffee from the brew region into the carafe;
a heating source element 528 for selectively heating fluid within the carafe reservoir.

In this embodiment, by way of example only, a surface 532 can be used to support the carafe 520, which is further associated with a load cell element 554. Placement of the carafe on the surface 532 causes movement or pressure applied by the carafe to the load cell element 554, which causes the load cell element to produce and transmit a signal to the control module 552 for indicating the presence of the carafe. A control module 552 is coupled to the load cell element 554 for receiving the load signal indicative of the carafe being provided to the drip filter coffee apparatus. It will be appreciated that in some embodiments, the signal transmitted by the load cell element to the control module can be further indicative of the carafe weight (and fluid volume within the carafe). The controller module 552 is also coupled to the heating source 528 for providing selective controlled heating of the fluid in the carafe reservoir. A controlled dispenser valve 558 can be coupled to the control module 552 for enabling controlled release of heated water into a brew region 562 and/or controlled release of the brewed coffee from a brew region 562 into the carafe. It would be appreciated that controlled release of brewed coffee from the brew region 562 (typically including a brew basket or filter) can enable an extended brew time for the coffee grounds in the brew chamber—prior to release into the carafe. A temperature sensor, for example in the form of an thermistor 556, can be located within or about (and preferably thermally coupled to) the reservoir for provided for temperature sensing of fluid within the carafe. By way of example, a wireless thermistor can be used to transmit a temperature signal to the control or processor module.

Referring to FIG. 6, control of a drip filter coffee apparatus 600, can be enhanced for providing temperature controlled heating (or pre-heating) of a thermally insulated carafe. In an embodiment, a control module 610 can be coupled to any one or more of the following:
a load cell element 612 for detecting presence and/or weight of a carafe and providing a load signal to the control module;
a temperature sensing element 614 for providing a temperature signal to the control module that is indicative of fluid temperature within the carafe;
a controlled water dispenser valve 616 for controlling flow of heated water into the brew region;
a controlled brew dispensing valve 617 for controlling release of brewed coffee from the brew region into the carafe;
a heating source element 618 for enabling selective heating of fluid within the carafe reservoir.

It will be appreciated that a load cell element 612 can be coupled to the control module 610, and provide a signal indicative of a carafe being present and/or weight of the presented carafe. The weight of the presented carafe can be indicative of fluid held in the carafe reservoir. A load cell element can communicate a load signal to the control module via a wireless and/or wired communication medium.

It will be appreciated that a temperature sensing element 614 can be coupled to the control module 610 for providing a signal indicative of fluid temperature within the carafe reservoir. The temperature sensing element can be a remote temperature sensing element and/or a local temperature sensing element. By way of example, a temperature sensing element can be in the form of an infrared, sensor and/or a thermistor. A temperature sensing element can communicate a temperature signal to the control module via a wireless and/or wired communication medium.

It would be appreciated that a controlled dispensing valve 616 can be controlled by the control module. The control module can selectively activate the controlled dispenser valve 616 for dispensing heated water into the brew region.

It would be appreciated that a controlled dispensing valve 617 can be controlled by the control module. The control module can selectively activate the controlled dispenser valve 617 for selectively controlling a brew dispensing valve to release brewed coffee from the brew region to the carafe. It will be appreciated that by selectively controlling the release of brewed coffee from the brew region, a predetermined (or user selected) brew time can be achieved.

It will be appreciated that a heating source element 618 can be selectively controlled by the control module for enabling heating fluid in the carafe reservoir. By way of example only, the heating source element can be in the form of a heating element (such as a warming bulb or infrared bulb) or an induction element cooperating with an inductive metal element; or a conventional electric heating element thermally coupled to the reservoir. Selective control of the heating source element can enable: pre-heating of the reservoir and/or re-warming of fluid in the reservoir and/or keeping fluid in the reservoir at a predetermined (or user selected) temperature.

It will be appreciated that a thermally insulated carafe can further include any one or more feature that is taught by United States Patent Application Publication No 2009/0308878 A1, which is hereby incorporated by reference in its entirety.

By way of example only, vacuum integrity of the body can be maintained by providing an interior partition passage between the interior of the cap opening and reservoir. Thermal insulation is provided by a vacuum region established between the internal reservoir and external body sidewall and/or base. The vacuum region being evacuated to form a thermally insulating vacuum.

By way of example only, a cap opening can be an eccentric or off centre opening. It will be appreciated that when the opening is smaller, rather than larger, the opening will not be or need not be coincident with the longitudinal centreline of the body. In examples of this kind, coffee from the drip coffee maker can enter the centre of the lid and be diverted into the opening by diverting it or through conduits located in the superstructure (or otherwise).

By way of example only, a carafe can include a removable lid. The lid can have a fill opening, the fill opening being in fluid communication with the reservoir. The fill opening can communicate with a passageway that leads to a counterweighted pivoting door that is normally closed to aid in heat retention, but opens when, for example, brewed coffee passes from the fill opening to the interior of the reservoir. Similarly, a rotating door can be interposed between a pour spout and the reservoir, and is normally closed to assist in the retention of heat but pivots to open when the carafe is tilted during pouring.

By way of example only, a carafe can include a level indicator mechanism. A level indicator mechanism can include a gauge float comprising a buoyant body carried by an arm. Rotation of the gauge float as the fluid level changes mechanically translates to movement of a gauge dial indicator that is visible through a view window located on a superstructure of the carafe.

By way of example only, a carafe can include a temperature sensor (not shown). The temperature sensor can also be operatively associated with (or coupled to) the internal reservoir, for monitoring temperature of the coffee within the reservoir. A temperature sensor can be coupled to a couple elements such that temperature data can be transferred to a supporting apparatus—thereby enabling a control module to activate and disable the heating source and thereby controlling the temperature of coffee held within the reservoir.

By way of example only, a carafe can include as handle that is snap fit or otherwise affixed onto the carafe.

It will be appreciated that the disclosed embodiments can further provide insulation of the carafe in alternative forms, such as: air insulated between the carafe walls (with, or without, a check valve); or insulated using an insulation medium (or material) between the carafe walls—without the need to provide a vacuum between the carafe walls.

It will be appreciated that the illustrated embodiments teach a thermally insulated vacuum carafe having an internal reservoir, wherein fluid in the internal reservoir can be heated or temperature controlled/regulated.

It will be appreciated that the disclosed insulated carafes and drip filter coffee apparatus, provide an advantage of enabling controlled heating of brewed coffee within these insulated carafes. This advantage is highlighted further when used in cooler climates. This controlled heating further reduces unnecessary “stewing” of the brewed coffee—typically experience when using a single wall glass carafe on a permanent heater plate after the coffee is brewed.

By gently warming the brewed coffee within these insulated carafes to expected temperatures, and thereby applying as little energy as necessary, a beneficial flavour can be achieved.

It will be appreciated that, any thermal insulating gap between the outer and inner walls of the carafe makes it difficult to warm the coffee therein.

By way of example only, a dual wall glass carafe can be warmed by a heat globe (for example a Halogen heat globe) situated underneath. The brewed coffee within the carafe receives the globes energy and can be kept warm or heated depending on power applied to heat globe. The internal skin may be painted or etched to better receive the globes energy. A load sensor located under the carafe determines when the carafe is in place, then sends a positive signal to a processor module. Only then will the machine open a drip stop valve and begin brewing coffee, which stops coffee being dispensed into the drip tray (particularly useful for delay start where user may forget to place carafe in position). The carafe load sensor monitors weight increase in carafe and sends a load signal to the processor module. When the processor module determines a users required volume has been brewed, a signal is sent to stop brewing and close the drip stop valve. A temperature sensor (for example a IR sensor or embedded negative temperature coefficient resistors) can monitor the temperature of coffee within the carafe. This information is sent to the processor module which in turn determines how much power to supply to the heat globe. The coffee temperature target can either be a default program or selected by the user. Once this temperature has been reached, the processor module applies enough power to the heat globe to maintain this temperature. It is noted that this method of temperature control could also be applied to glass single wall carafe.

By way of example only, a dual wall glass carafe can be warmed by using ferrous substrate that is applied to the internal wall. This ferrous substrate can be silk screened. An inductive coil located in the drip filter coffee apparatus, typically under the carafe, for applying an inductive field that energises the applied ferrous substrate and subsequently warms the coffee. A load sensor and/or a temperature sensor can be included as set out in the previous example.

By way of example only, a dual wall stainless steel carafe can be warmed by using a ferrous plate or cover bonded to the internal wall. This ferrous place can be impact bonded. An inductive coil located in the drip filter coffee apparatus, typically under the carafe, for applying an inductive field that energising the applied ferrous plate and subsequently warms the coffee. A load sensor can be included as set out in the previous example. A temperature sensor (for example, incorporating an embedded negative temperature coefficient resistors) can be used in monitoring the temperature of coffee within the carafe. This information is sent to the processor module which in turn determines how much power to supply to the heat globe. The coffee temperature target can either be a default program or selected by the user. Once this temperature has been reached, the processor module applies enough power to the heat globe to maintain this temperature.

By way of example only, a dual wall stainless steel carafe is modified to be single wall at the base, for receiving a conductive heater plate (for example, aluminium) which enable transmission of heat. A drip fitter coffee apparatus has a heating element located beneath the heater plate for warming the coffee within the carafe. A load sensor can be included as set out in the previous examples. A temperature sensor (for example, incorporating an embedded negative temperature coefficient resistors) can be used as described in the previous example.

By way of example only, a dual wall stainless steel carafe can be warmed by a heating element (for example printed element or coil element) that is bonded to the internal wall of a carafe. A drip fitter coffee apparatus has an electrical coupling for applying power to the heating element. A traditional kettle controller can be located in the apparatus or carafe for controlling the temperature of coffee. A load sensor can be included as set out in the previous examples. A temperature sensor (for example, incorporating an embedded negative temperature coefficient resistors) can be used as described in the previous example.

Each of the above embodiments can provide the consumer with efficiently heated, hotter coffee. By maintaining thermal insulation between the outer and inner skin/wall—exterior surfaces which are cool to touch; and keeping coffee hotter for longer when removed from the drip filter coffee apparatus.

Although the invention has been described with reference to specific examples, it will be appreciated by those skilled in the art that the invention may be embodied in many other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not he interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. An insulated carafe device, the device including:
a body that comprises an outer sidewall;
an internal wall that forms an internal reservoir;
the outer sidewall and internal wall defining a cavity there between; and
the internal reservoir being adapted to be heated by a heat source.

2. The device according to claim 1, wherein a base of the internal reservoir is adapted to receive heat from the heat source.

3. The device according to claim 2, wherein the heat source is remote from a base portion of the internal reservoir.

4. The device according to claim 2, wherein the heat source is coupled to a base portion of the internal reservoir.

5. The device according to claim 3, wherein the cavity includes a vacuum cavity.

6. The device according to claim 5, wherein the cavity includes a plurality of vacuum cavities.

7. The device according to claim 5, wherein each vacuum cavity provide thermal insulation for the internal reservoir.

8. The device according to claim 5, wherein an upper extremity of the outer sidewall has a cap.

9. The device according to claim 8, wherein the cap includes an opening.

10. The device according to claim 9, wherein the internal reservoir is in fluid communication with the cap opening.

11. The device according to claim 3, wherein the lower portion of the body comprises a base portion adjoining a lower extremity of the outer sidewall.

12. A thermally insulated carafe device, the device including:
an outer side wall; and
an inner sidewall that define a chamber there between, the inner sidewall forming an internal reservoir for retaining fluid therein; and
an opening being in fluid communication with the reservoir; and
wherein the internal reservoir is adapted to be heated by a remote heat source.
